(19) United States
(12) Patent Application Publication
(10) Pub. No.: US 2022/0163720 A1
(43) Pub. Date: May 26, 2022

(54) OPTICAL WAVEGUIDE ELEMENT AND OPTICAL WAVEGUIDE DEVICE

(71) Applicant: SUMITOMO OSAKA CEMENT CO., LTD., Tokyo (JP)

(72) Inventors: Yuki Kugimoto, Tokyo (JP); Norikazu Miyazaki, Tokyo (JP); Yu Kataoka, Tokyo (JP)

(21) Appl. No.: 17/599,721

(22) PCT Filed: Sep. 26, 2019
(86) PCT No.: PCT/JP2019/037939

§ 371 Date: Sep. 29, 2021

(30) Foreign Application Priority Data
Mar. 29, 2019 (JP) 2019-067620

(51) Int. Cl. G02B 6/125; G02F 1/035; G02F 1/21; G02F 1/225; G02B 6/122

(52) U.S. Cl. CPC G02B 6/125; G02F 1/0356; G02B 2006/12142; G02F 1/2255; G02B 6/1223; G02F 1/212

(57) ABSTRACT

In an optical waveguide element, performance deterioration due to recoupling of unnecessary light leaking from an optical waveguide with the optical waveguide is prevented. An optical waveguide element includes an optical substrate on which an optical waveguide is formed, and a support substrate that is bonded to the optical substrate, on a bonded surface of the support substrate bonded to the optical substrate, a recess portion along the optical waveguide on the optical substrate is formed directly under the optical waveguide, a portion of the support substrate from an upper surface of the support substrate to at least a depth of a bottom surface of the recess portion has a refractive index higher than a substrate refractive index of the optical substrate, and the recess portion is filled with a substance having a refractive index lower than the substrate refractive index.

### TECHNICAL FIELD

The present invention relates to an optical waveguide element that is a functional element using an optical waveguide, such as an optical modulation element, and an optical waveguide device using such an optical waveguide element.

### BACKGROUND ART

In high-speed/large-capacity optical fiber communication systems, optical transmission apparatuses incorporating a waveguide type optical modulator are often used. Above all, an optical modulation element using LiNbO₃ (hereinafter, also referred to as LN) having an electro-optic effect for a substrate has low light loss and can realize a wide-band optical modulation characteristic compared with an optical modulation element using a semiconductor-based material such as indium phosphide (InP), silicon (Si), or gallium arsenide (GaAs), and is thus widely used in high-speed/large-capacity optical fiber communication systems.

On the other hand, in a modulation method in an optical fiber communication system, multi-level modulation such as quadrature phase shift keying (QPSK) or dual polarization-quadrature phase shift keying (DP-QPSK) or transmission formats in which polarization multiplexing is incorporated into the multi-level modulation have become the mainstream in response to the recent trend of increasing transmission capacity.

The acceleration of the spread of Internet services in recent years has led to a further increase in communication traffic, and studies on further miniaturization, widening a bandwidth, and power saving of optical modulation elements are still underway.

As one measure for miniaturization, widening a bandwidth, and power saving of such an optical modulation element, for example, an optical modulation element using a rib-type waveguide (hereinafter, rib-type optical modulation element) is being studied (for example, refer to Patent Literature No. 1). In the rib-type waveguide, a substrate using LN is thinly processed, and other portions are further thinned (for example, to a substrate thickness of 10 μm or less) while leaving a desired striped portion (rib) through dry etching or the like. Therefore, an effective refractive index of the rib portion is made higher than that of the other portions to form an optical waveguide.

However, as a result of thinly processing the substrate to a thickness of several μm or less, a new problem may occur. That is, in an optical waveguide element such as an optical modulation element that uses an optical waveguide formed on a substrate, generally, an optical coupling portion between an optical fiber for light input and an optical waveguide, a light branching section such as a Y-branch waveguide, and/or a curved waveguide portion where a propagation direction of light changes, light propagating in the optical waveguide may leak into the substrate and become unnecessary light. Such unnecessary light is reflected in the substrate and then coupled with the optical waveguide again to become noise light. Thus, for example, in an optical modulation element, an extinction ratio of an optical modulation waveform may decrease.

In particular, in a case where a substrate thinly processed as described above is used, there is a high probability that unnecessary light once leaking into the substrate may be reflected a plurality of times in the substrate and then recoupled with the optical waveguide due to a decrease in a sectional area in a thickness direction of the substrate or a decrease in a volume of the substrate. As a bandwidth is further widened as described above, stricter required conditions may be imposed on the extinction ratio. Therefore, it can be expected that restrictions on optical characteristics such as a decrease in the extinction ratio due to unnecessary light are imposed will become a big problem in the future.

### CITATION LIST

### Patent Literature

[Patent Literature No. 1] Japanese Laid-open Patent Publication No. 2011-75917

### SUMMARY OF INVENTION

### Technical Problem

From the above background, in an optical waveguide element using a thinly processed substrate such as a rib-type optical modulation element, it is desirable to prevent performance deterioration due to recoupling of unnecessary light leaking from an optical waveguide with the optical waveguide.

### Solution to Problem

According to an aspect of the present invention, there is provided an optical waveguide element including an optical substrate on which an optical waveguide is formed; and a support substrate that is bonded to the optical substrate, on a bonded surface of the support substrate bonded to the optical substrate, recess portion along the optical waveguide on the optical substrate is formed directly under the optical waveguide, in which a refractive index of a portion including the bonded surface of the support substrate is higher than a substrate refractive index of the optical substrate, and the recess portion is filled with a substance having a refractive index lower than the substrate refractive index.

According to another aspect of the present invention, the optical substrate has a thickness that is equal to or less than twice a vertical mode field diameter of light propagating through the optical waveguide, the vertical mode field diameter being a diameter of said light in a thickness direction of the optical substrate.

According to still another aspect of the present invention, the recess portion is formed such that a groove width of the recess portion measured in a direction orthogonal to an extending direction of the optical waveguide is equal to or more than a horizontal mode field diameter of the light propagating through the optical waveguide, measured in a plane direction of the optical substrate.

According to still another aspect of the present invention, the optical substrate and the support substrate are bonded to each other with an adhesive layer interposed therebetween, and the adhesive layer is formed to have a thickness that is equal to or less than 1/50 of a vertical mode field diameter of light propagating through the optical waveguide, the vertical mode field diameter being a diameter of said light in a thickness direction of the optical substrate.

According to still another aspect of the present invention, the recess portion is formed at a depth that is equal to or more than 1/40 of a vertical mode field diameter of light propagating through the optical waveguide, the vertical mode field diameter being a diameter of said light in a thickness direction of the optical substrate.

According to still another aspect of the present invention, the optical substrate is provided with a signal line disposed along the optical waveguide and controlling an optical wave propagating through the optical waveguide, the recess portion is configured such that a groove width of the recess portion measured in a direction orthogonal to an extending direction of the optical waveguide includes at least a part of a gap between electrodes forming the signal line, and the substance has a dielectric constant lower than a dielectric constant of the optical substrate.

According to still another aspect of the present invention, the support substrate is a multilayer substrate including a plurality of layers made of different materials.

According to still another aspect of the present invention, the support substrate is configured such that a refractive index is distributed in a thickness direction.

According to still another aspect of the present invention, the substance includes at least one of air, nitrogen, a resin, SiOₓ, Al₂O₃, MgF₂, and CaF₂.

According to still another aspect of the present invention, there is provided an optical waveguide device including any one of the optical waveguide elements; and a housing that houses the optical waveguide element.

It should be noted that this specification includes all the content of the Japanese Patent Application No. 2019-067620 filed on Mar. 29, 2019.

### Advantageous Effects of Invention

According to the present invention, in an optical waveguide element using a thinly processed substrate such as a rib-type optical modulation element, it is possible to suppress recoupling of unnecessary light leaking from an optical waveguide with the optical waveguide and thus to prevent performance deterioration due to the recoupling.

### BRIEF DESCRIPTION OF DRAWINGS

FIG. 1 is a diagram illustrating a configuration of an optical modulation device according to a first embodiment of the present invention.

FIG. 2 is a diagram illustrating a configuration of an optical modulation element used in the optical modulation device illustrated in FIG. 1.

FIG. 3 is a sectional view taken along the line AA of the optical modulation element illustrated in FIG. 2.

FIG. 4 is a diagram illustrating a first modification example of an optical modulation element that can be used in the optical modulator illustrated in FIG. 1.

FIG. 5 is a diagram illustrating a second modification example of an optical modulation element that can be used in the optical modulator illustrated in FIG. 1.

FIG. 6 is a diagram illustrating a third modification example of an optical modulation element that can be used in the optical modulator illustrated in FIG. 1.

FIG. 7 is a diagram illustrating a fourth modification example of an optical modulation element that can be used in the optical modulator illustrated in FIG. 1.

FIG. 8 is a diagram illustrating a fifth modification example of an optical modulation element that can be used in the optical modulator illustrated in FIG. 1.

FIG. 9 is a diagram illustrating a configuration of an optical modulation device according to a second embodiment of the present invention.

FIG. 10 is a diagram illustrating a configuration of an optical modulation element used in the optical modulation device illustrated in FIG. 9.

FIG. 11 is a sectional view taken along the line BB of the optical modulation element illustrated in FIG. 10.

FIG. 12 is a diagram illustrating another example of the optical modulation element according to the present invention.

### DESCRIPTION OF EMBODIMENTS

Hereinafter, embodiments of the present invention will be described with reference to the drawings. An optical waveguide element according to the embodiments described below is an optical modulation element configured by using an LN substrate, but the optical waveguide element according to the present invention is not limited to this. The present invention can be similarly applied to an optical waveguide element using a substrate other than the LN substrate and an optical waveguide element having a function other than optical modulation.

### First Embodiment

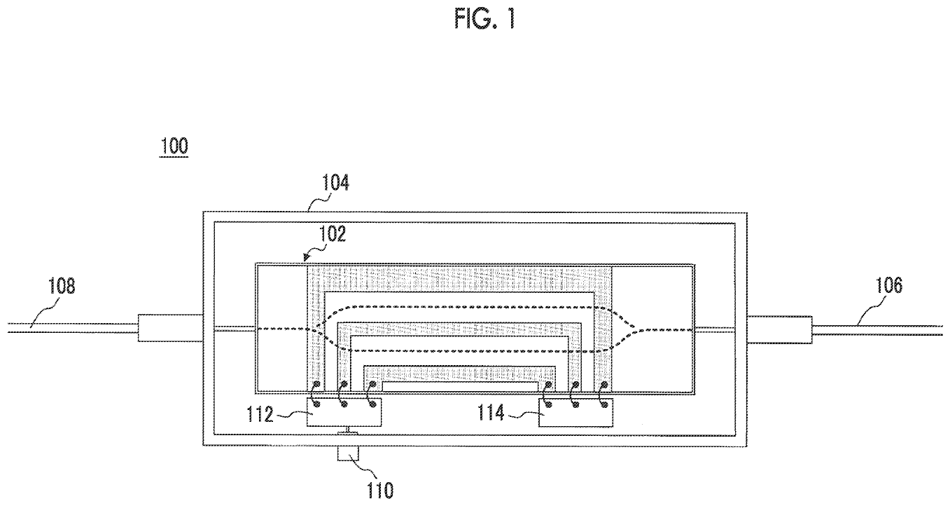

FIG. 1 is a diagram illustrating a configuration of an optical waveguide element and an optical waveguide device according to a first embodiment of the present invention. In the present embodiment, the optical waveguide element is an optical modulation element 102 that performs optical modulation by using a Mach-Zehnder optical waveguide, and the optical waveguide device is an optical modulation device 100 that uses the optical modulation element 102.

The optical modulation device 100 houses the optical modulation element 102 inside a housing 104. A cover (not illustrated) which is a plate body is finally fixed to an opening of the housing 104, and the inside of the housing 104 is airtightly sealed.

The optical modulation device 100 further includes an input optical fiber 106 for inputting light into the housing 104, and an output optical fiber 108 for guiding light modulated by the optical modulation element 102 to the outside of the housing 104.

The optical modulation device 100 also has a connector 110 for receiving a high-frequency electrical signal for causing the optical modulation element 102 to perform an optical modulation operation from the outside, and a relay substrate 112 for relaying the high-frequency electrical signal received by the connector 110 to one end of a signal electrode of the optical modulation element 102. The optical modulation device 100 includes a terminator 114 having a predetermined impedance, which is connected to the other end of the signal electrode of the optical modulation element 102. Here, the signal electrode of the optical modulation element 102, and the relay substrate 112 and the terminator 114 are electrically connected to each other, for example, through bonding of, a metal wire or the like.

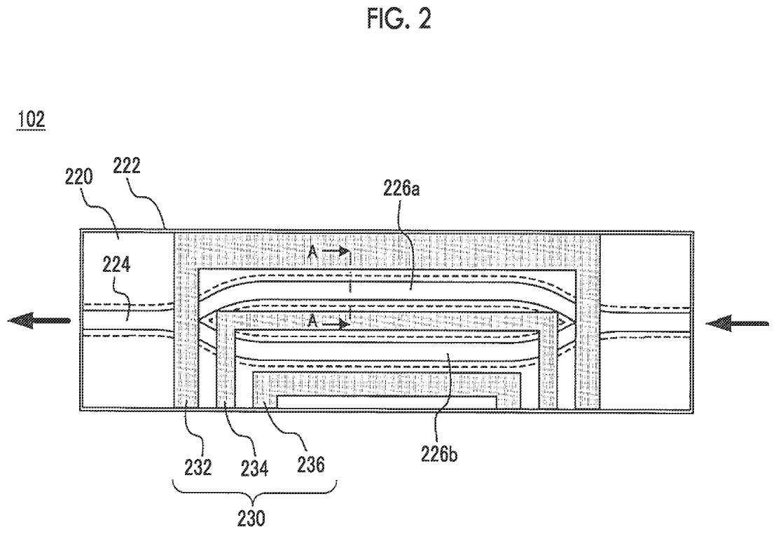

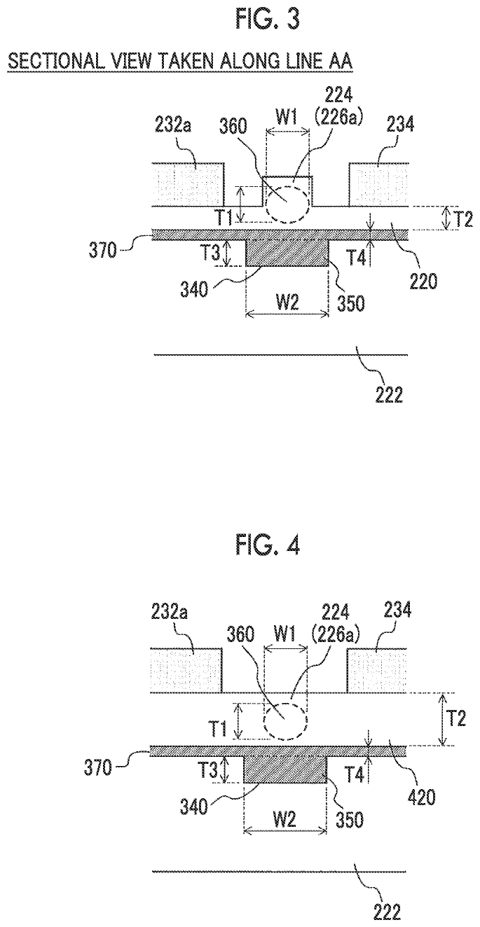

FIG. 2 is a diagram illustrating a configuration of the optical modulation element 102 that is an optical waveguide element housed in the housing 104 of the optical modulation device 100 illustrated in FIG. 1. FIG. 3 is a sectional view taken along the line AA of the optical modulation element 102 illustrated in FIG. 2.

The optical modulation element 102 includes, for example, an optical substrate 220 made of LN and a support substrate 222 that supports the optical substrate 220. An optical waveguide 224 (corresponding to a thick dotted line shown in the optical modulation element 102 illustrated in FIG. 1) is formed on the optical substrate 220. Here, the optical substrate 220 is thinly processed to a thickness of, for example, 1 to 2 μm or less, and the optical waveguide 224 is a so-called rib-type optical waveguide in which a portion of the optical waveguide 224 is formed thicker than other portions of the optical substrate 220 (for example, at a thickness of several μm). Consequently, an effective refractive index in the optical waveguide 224 becomes higher than that in other portions, and light is confined in the optical waveguide 224 and guided.

The optical waveguide 224 is, for example, a Mach-Zehnder optical waveguide, and includes two branching sections and two parallel waveguides 226a and 226b extending in parallel with each other. A signal electrode 230 is also provided on the optical substrate 220 to control a optical wave propagating in the parallel waveguides 226a and 226b by changing refractive indexes of the parallel waveguides 226a and 226b. The signal electrode 230 configures a signal line that are disposed along the parallel waveguides 226a and 226b that are a part of the optical waveguide 224 and controls optical waves propagating along the parallel waveguides 226a and 226b.

Specifically, the signal electrode 230 includes electrodes 232 and 236 corresponding to two ground electrodes, and an electrode 234 that is a center electrode disposed to be sandwiched between the electrodes 232 and 236 in a plane of the optical substrate 220. Here, the optical substrate 220 is made of, for example, X-cut LN, and the signal electrode 230 generates an electric field along the plane direction of the optical substrate 220 with respect to the parallel waveguides 226a and 226b, to change the refractive indexes of the parallel waveguides 226a and 226b, and thus causes the optical waveguide 224 that is a Mach-Zehnder optical waveguide to perform an optical modulation operation. The thick arrows illustrated on the right and left sides of FIG. 2 indicate an input direction and an output direction of the light.

In particular, in the optical modulation element 102 that is the optical waveguide element of the present embodiment, the support substrate 222 is made of a material having a refractive index n3 larger than a substrate refractive index n1 which is a refractive index of the optical substrate 220 (that is, n3>n1). In the support substrate 222, a recess portion 340 is formed on a bonded surface with the optical substrate 220 along the optical waveguide 224 on the optical substrate 220, directly under the optical waveguide 224. Specifically, in the present embodiment, the recess portion 340 is formed such that a groove width W2 measured in a direction orthogonal to the extending direction of the optical waveguide 224 includes a width of the optical waveguide 224 (FIG. 3).

The inside of the recess portion 340 is also filled with a substance (filling substance) 350 having a refractive index n2 smaller than the substrate refractive index n1 (that is, n2<n1<n3). Here, the filling substance 350 may be, for example, a resin.

In the present embodiment, the support substrate 222 is made of, for example, Si having a refractive index larger than the refractive index of the LN forming the optical substrate 220. The filling substance 350 is made of a resin having a refractive index smaller than the refractive index of the LN and which can also be used for adhesion between the optical substrate 220 and the support substrate 222.

In the present embodiment, the optical substrate 220 is bonded (adhered) to the support substrate 222 via an adhesive layer 370. In the present embodiment, the adhesive layer 370 is made of the resin forming the filling substance 350.

Here, a thickness T4 of the adhesive layer 370 needs to be small such that light propagating through the optical waveguide 224 can be sufficiently leaked out of the optical substrate 220 toward the support substrate 222.

In the optical modulation element 102 having the above configuration, since the support substrate 222 having the refractive index n3 higher than the substrate refractive index n1 of the optical substrate 220 is bonded to the optical substrate 220, unnecessary light leaking into the optical substrate 220 from the optical waveguide 224 easily propagates to the support substrate 222, but it becomes difficult for the leaking unnecessary light to be input to the optical substrate 220 from the support substrate 222. Since the support substrate 222 is provided with the recess portion 340 filled with the filling substance 350 having the refractive index n2 smaller than the substrate refractive index n1 along the optical waveguide 224 formed on the optical substrate 220, it is difficult for light propagating through the optical waveguide 224 to leak toward the support substrate 222 having a high refractive index, and is thus the light is confined in the optical waveguide 224.

That is, in the optical modulation element 102, while confining guided light in the optical waveguide 224 is sufficiently ensured, unnecessary light generated in the optical coupling portion with the input optical fiber 106, the branching section, the curved waveguide portion, and/or the like is diffused and eliminated toward the support substrate 222 having a high refractive index directly under the optical substrate 220. Thus, in the optical modulation element 102, it is possible to effectively suppress recoupling of unnecessary light leaking from the optical waveguide 224 to the optical substrate 220 with the optical waveguide 224. Therefore, in the optical modulation element 102, it is possible to effectively suppress the deterioration in the performance due to the recoupling of unnecessary light with the optical waveguide 224, for example, the deterioration in the extinction ratio in an optical modulation waveform.

FIG. 3 illustrates the portion of the parallel waveguide 226a taken out as an example in order to show the configuration around the optical waveguide 224, and the other portions of the optical waveguide 224 including the parallel waveguide 226b are similarly configured. In a portion where two recess portions 340 provided for each of the parallel waveguides 226a and 226b approach each other along the optical waveguide 224, such as in the vicinity of the optical coupling portion and the branching section, the recess portions 340 may be configured to be combined into one recess portion having a groove width twice the maximum W2 such that the groove width converges to W2 according to a clearance between the two optical waveguides.

Here, a depth T3 of the recess portion 340 provided in the support substrate 222 is required to be a depth at which the recess portion 340 filled with the filling substance 350 can effectively function as a clad layer of the optical waveguide 224 in relation to a wavelength of light propagating in the optical waveguide 224. A range of desirable values of T3 may be expressed, for example, in relation to a size of a mode field 360 (FIG. 3) of guided light in the optical waveguide 224, which is closely related to the wavelength as described above, and is preferably equal to or more than 1/40 of a vertical mode field diameter T1 of at least the mode field 360 (that is, T3≥T1/40). This condition may be applied regardless of whether the mode field 360 is in a single mode or a multimode. The vertical mode field diameter T1 refers to a diameter of the mode field 360 measured in the thickness direction of the optical substrate 220.

In the present embodiment, the recess portion 340 formed in the support substrate 222 is formed such that the groove width W2 includes the width of the optical waveguide 224 (FIG. 3), but, in principle, the groove width W2 of the recess portion 340 may be a horizontal mode field diameter W1 or more (that is, W2≥W1) of the mode field 360. Consequently, the recess portion 340 can cover the entire spread of the mode field 360 in a horizontal direction, and the filling substance 350 in the recess portion 340 can sufficiently achieve alight confinement effect of the optical waveguide 224. Here, the horizontal direction refers to the plane direction of the optical substrate 220, and the horizontal mode field diameter refers to a diameter of the mode field 360 measured in the plane direction of the optical substrate 220.

The thickness T4 of the adhesive layer is required to be a thickness at which sufficient light leakage from the optical substrate 220 to the support substrate 222 is ensured in relation to a wavelength of light propagating through the optical waveguide 224. A range of desirable values of T4 may be expressed, for example, in relation to a size of the mode field 360 (FIG. 3) of guided light in the optical waveguide 224, which is closely related to the wavelength as described above, and is preferably equal to or less than 1/50 of the vertical mode field diameter T1 of at least the mode field 360 (that is, T4≤T1/50).

A material of the adhesive layer may be a thin film formed by dry process or a sol-gel process (for example, a thin film such as an oxide such as SiOₓ or Al₂O₃ or a fluoride such as MgF₂ or CaF₂) or may be a coating film of a resin-based material.

The effect of eliminating unnecessary light by bonding the support substrate 222 having a high refractive index is remarkable, for example, in a case where the thickness T2 of the optical substrate 220 is equal to or less than twice the vertical mode field diameter T1 of the mode field 360 of the guided light (T2≤2×T1). This condition may be applied regardless of whether the optical waveguide 224 is manufactured as a ridge type waveguide as in the present embodiment, or a waveguide (hereinafter, a planar waveguide) configured on the surface layer of the optical substrate 220 by using metal diffusion of Ti or the like without providing a ridge.

FIG. 4 is a diagram illustrating a first modification example of the optical modulation element 102 in a case where the optical waveguide 224 is configured with such a planar waveguide. Here, FIG. 4 corresponds to the sectional view of FIG. 3. In the example illustrated in FIG. 4, the optical waveguide 224 is configured with a planar waveguide in an optical substrate 420 having the thickness T2 of about 1.5 times the vertical mode field diameter T1 of the guided light. Even in a case where the optical waveguide 224 is configured with such a planar waveguide, it is possible to effectively eliminate unnecessary light generated in the optical substrate 220 while enhancing the light confinement effect in the optical waveguide 224 as in the case of using the ridge type optical waveguide illustrated in FIG. 3.

In the present embodiment, the filling substance 350 filling the recess portion 340 of the support substrate 222 is a resin, but the present invention is not limited to this. The filling substance 350 may be a material having a solid, liquid, or gas phase at the normal operating temperature of the optical modulation element 102 as long as the material has the refractive index n2 smaller than the substrate refractive index n1 of the optical substrate 220. For example, the filling substance 350 may be a gas such as air or nitrogen. For example, the filling substance 350 may contain at least one of air, a resin, an oxide such as SiOₓ and Al₂O₃, and a fluoride such as MgF₂ and CaF₂, or may be a combination thereof.

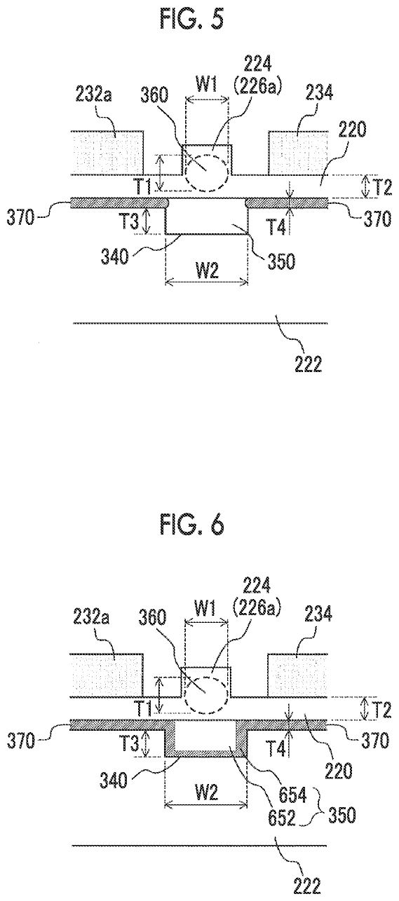

FIG. 5 is a diagram illustrating a second modification example of the optical modulation element 102, and illustrates an example in which a gas is used as the filling substance 350. Here, FIG. 5 corresponds to the sectional view of FIG. 3. In the example illustrated in FIG. 5, the recess portion 340 of the support substrate 222 is filled with a gas such as air as the filling substance 350, and the adhesive layer 370 made of an adhesive resin is formed in a gap portion between the support substrate 222 and the optical substrate 220 other than the recess portion 340 and bonds the support substrate 222 to the optical substrate 220. Even with this configuration, as long as the filling substance 350 has the refractive index n2 smaller than the substrate refractive index n1, it is possible to effectively eliminate unnecessary light generated in the optical substrate 220 while enhancing the light confinement effect in the optical waveguide 224 as in the configuration in FIG. 3.

The filling substance 350 filling the recess portion 340 does not have to be a single material, but a plurality of materials may be combined and the respective materials may fill different locations in the recess portion 340.

FIG. 6 is a diagram illustrating a third modification example of the optical modulation element 102. Here, FIG. 6 corresponds to the sectional view of FIG. 3. In the example illustrated in FIG. 6, air 652 and a resin 654 forming the adhesive layer 370 are used in combination as the filling substance 350, and the resin 654 is disposed along the inner side surface of the recess portion 340 and the air 652 fills the inside of the recess portion 340. Even with this configuration, as long as each material forming the filling substance 350 has a refractive index smaller than the substrate refractive index n1, or a material forming the filling substance 350 and disposed at a location in contact with at least the optical substrate 220 has a refractive index smaller than the refractive index n1 of the substrate, it is possible to effectively eliminate unnecessary light generated in the optical substrate 220 while enhancing the light confinement effect in the optical waveguide 224 as in the configuration in FIG. 3.

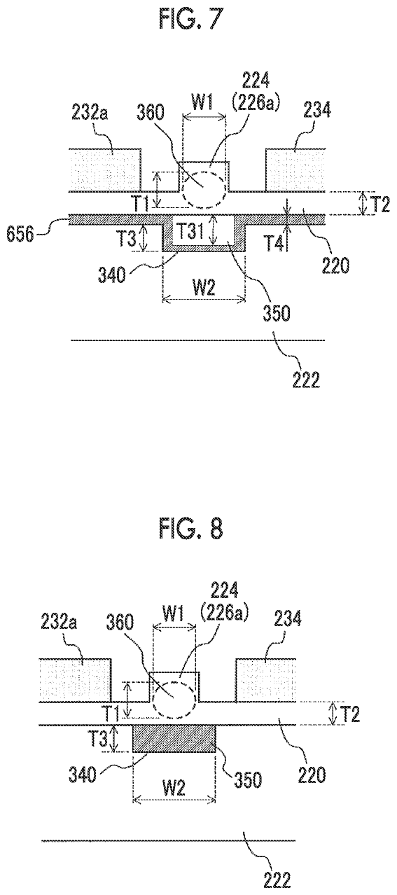

The configuration as illustrated in FIG. 6 is not limited to a configuration in which the resin 654 is used for a part of the filling substance 350 and the adhesive layer 370. FIG. 7 is a diagram illustrating a fourth modification example of the optical modulation element 102 having the same configuration as that in FIG. 6. In the configuration illustrated in FIG. 7, an intermediate layer 656 is formed on the support substrate 222 on which the recess portion 340 is formed by using a film forming technique such as sputtering. As illustrated in FIG. 7, the intermediate layer 656 may be formed only on the bottom surface and the side surface of the recess portion 340, or may be formed only on the bottom surface of the recess portion 340. The intermediate layer 656 may be, for example, a film of a material (for example, SiO₂) having the refractive index n2 having the above-described conditions as a part of the filling substance 350. The intermediate layer 656 may also be used as a bonding material between the optical substrate 220 and the support substrate 222. For example, bonding between the intermediate layer 656 and the optical substrate 220 may be performed through direct bonding using optical contact or the like, or through heat fusion using ultrasonic heating or the like with another layer of metal or the like (not illustrated) provided on the back surface of the optical substrate 220. Alternatively, when a depth T31 of the filling substance 350 filling a location of the recess portion 340 other than the intermediate layer 656 satisfies the same condition as the above-described condition for T3, for example, T31≥T1/40, the intermediate layer 656 does not necessarily form a part of the filling substance 350.

The optical substrate 220 and the support substrate 222 may be directly bonded to each other. FIG. 8 is a diagram illustrating a fifth modification example of the optical modulation element 102. Here, FIG. 8 corresponds to the sectional view of FIG. 3. In the example illustrated in FIG. 8, the optical substrate 220 and the support substrate 222 are directly bonded to be in contact with each other without an adhesive layer. Such bonding may be realized through, for example, optical contact between the optical substrate 220 and the support substrate 222.

In the first embodiment illustrated in FIGS. 1 to 3 and the modification examples of the first embodiment illustrated in FIGS. 4 to 8, the optical modulation element 102 is configured by using, for example, an X-cut LN substrate as the optical substrate 220, but is not limited to this. An optical modulation element may be configured by using a Z-cut LN substrate as the optical substrate 220.

### Second Embodiment

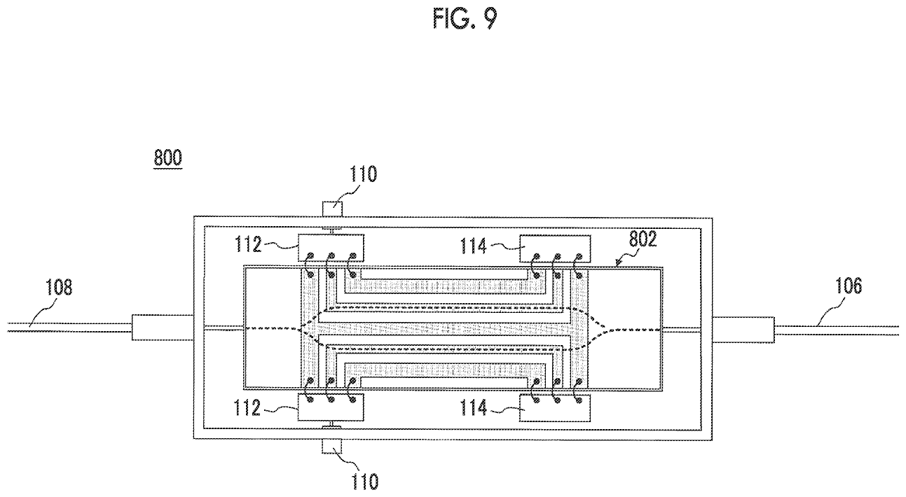

Next, a second embodiment of the present invention will be described. FIGS. 9, 10, and 11 are diagrams illustrating the configurations of an optical modulation element 802 that is an optical waveguide element according to the second embodiment of the present invention, and an optical modulation device 800 that is an optical waveguide device using the same.

In FIGS. 9, 10, and 11, the same reference numerals as those in FIGS. 1, 2, and 3 are used for the same constituents as those in FIGS. 1, 2 and 3 as described above, and the description of FIGS. 1, 2 and 3 will be incorporated.

The optical modulation device 800 illustrated in FIG. 9 has the same configuration as the optical modulation device 100 except that the optical modulation element 802 is used instead of the optical modulation element 102. In the optical modulation device 800, the optical modulation element 802 is different from the optical modulation device 100 in that the optical modulation element 802 has two signal electrodes 930a and 930b (described later) each having one center electrode, and thus has two connectors 110, two relay substrates 112, and two terminators 114 in correspondence with the respective two center electrodes.

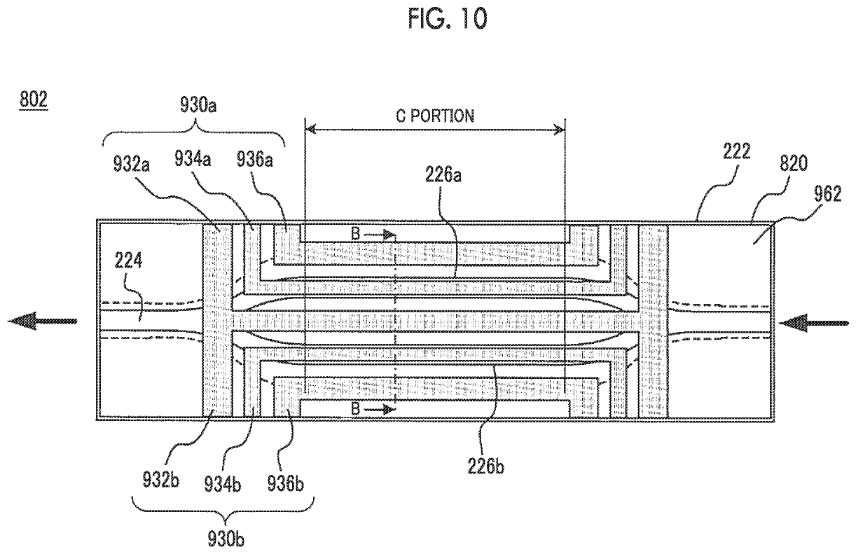

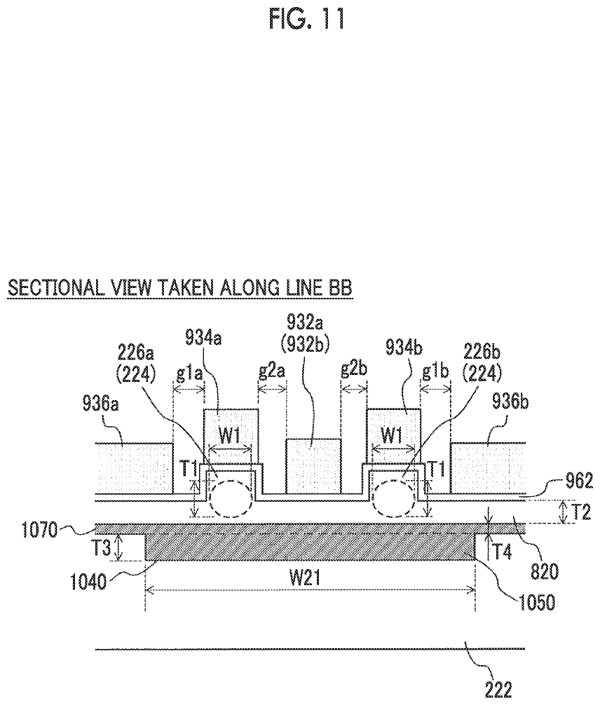

FIG. 10 is a diagram illustrating a configuration of the optical modulation element 802. FIG. 11 is a sectional view taken along the line BB of the optical modulation element 802 illustrated in FIG. 10. The optical modulation element 802 has the same configuration as that of the optical modulation element 102 except that the optical substrate 820 that is a Z-cut LN substrate is used instead of the optical substrate 220 that is an X-cut LN substrate. The optical modulation element 802 is different from the optical modulation element 102 in that, for example, a buffer layer 962 made of SiO₂ is formed on the optical substrate 820.

The optical modulation element 802 is different from the optical modulation element 102 using an X-cut LN substrate in that the optical substrate 820 is a Z-cut LN substrate. Therefore, two signal electrodes 930a and 930b for applying an electric field in the thickness direction of the optical substrate 820 are provided for the parallel waveguides 226a and 226b, respectively. Here, the signal electrodes 930a and 930b are respectively disposed along the parallel waveguides 226a and 226b, and form a signal line for controlling light propagating in the parallel waveguides 226a and 226b.

Specifically, the signal electrode 930a includes an electrode 934a that is a center electrode disposed on the buffer layer 962 right above the parallel waveguide 226a to extend along the parallel waveguide 226a, and electrodes 932a and 936a that are two ground electrodes disposed to sandwich the electrode 934a therebetween in a plane direction of the optical substrate 820.

The signal electrode 930b includes an electrode 934b that is a center electrode disposed on the buffer layer 962 right above the parallel waveguide 226b to extend along the parallel waveguide 226b, and electrodes 932b and 936b that are two ground electrodes disposed to sandwich the electrode 934b therebetween in the plane direction of the optical substrate 820. The electrodes 932a and 932b are connected to each other on the optical substrate 820.

In particular, in the optical modulation element 802, unlike the optical modulation element 102, the support substrate 222 is provided with a recess portion 1040 instead of the recess portion 340. Similar to the recess portion 340, the recess portion 1040 is provided along the optical waveguide 224 directly under the optical waveguide 224. However, a configuration of a location of the recess portion 1040 corresponding to the parallel waveguides 226a and 226b is different from that of the recess portion 340.

Specifically, a width W21 of the recess portion 1040 is formed to include gaps g1a and g2a between the electrodes 936a, 934a, and 932a of the signal electrodes 930a forming one signal line and gaps g1b and g2b between the electrodes 936b, 934b, and 932b of the signal electrode 930b forming the other signal line over at least a range (a range indicated by the reference sign C in FIG. 9) in the length direction of the parallel waveguides 226a and 226b of which refractive indexes are controlled by the signal electrodes 930a and 930b.

The inside of the recess portion 1040 is filled with a filling substance 1050 instead of the filling substance 350. As the filling substance 1050, a material having the refractive index n2 smaller than the substrate refractive index n1 of the optical substrate 820 and a dielectric constant lower than that of the optical substrate 820 is used as in the filling substance 350.

In the optical modulation element 802 having the above configuration, since the recess portion 1040 provided in the support substrate 222 is provided directly under the parallel waveguides 226a and 226b, in the same manner as the optical modulation element 102, unnecessary light leaking from the optical waveguide 224 to the optical substrate 820 can be eliminated to the support substrate 222 while sufficiently confining light in the optical waveguide 224, and it is possible to suppress deterioration in optical characteristics such as an extinction ratio due to the unnecessary light being recoupled with the optical waveguide 224.

In particular, in the optical modulation element 802, the recess portion 1040 is provided to have the groove width W21 including the gaps g1a, g2a, g1b, and g2b between the electrodes 932a and the like forming the signal lines, and is filled with the filling substance 1050 having a dielectric constant lower than a dielectric constant of the optical substrate 820. Thus, a propagation velocity of high-frequency electrical signals at the signal electrodes 930a and 930b can be brought close to a propagation velocity of light at the parallel waveguides 226a and 226b to be match with each other.

Consequently, in the optical modulation element 802, in addition to the effect of eliminating unnecessary light, a bandwidth in the optical modulation element 802 can be widened and a drive voltage can be reduced as a result of the velocity matching. In the configuration illustrated in FIGS. 10 and 11, the recess portion 1040 is formed to have the width W21 including all the gaps g1a, g2a, g2b, and g1b, but the present invention is not limited to this. As long as a recess portion such as the recess portion 1040 is configured to include at least a part of the support substrate 222 where an electric field is generated at each of the signal electrodes 930a and 930b forming the signal lines, the velocity matching effect can be achieved. Therefore, for example, in FIG. 11, the recess portion 1040 may be configured with two recess portions divided into the left and right sides in the figure, one recess portion having a width including at least a part of the gap g1a and/or g2a, and the other recess portion having a width including at least a part of the gaps g2b and g1b.

In the present embodiment, a Z-cut LN substrate is used as the optical substrate 820, but the present invention is not limited to this. As the optical substrate 820, an X-cut LN substrate may be used in the same manner as the optical substrate 220. In this case, the signal electrode 230 similar to that illustrated in FIG. 2 may be formed on the optical substrate 820. In this case, as illustrated in FIG. 3, as long as the recess portion 340 is formed in at least a part of a portion (a gap portion between the electrode 234 and the electrode 232a) of the support substrate 222 in which an electric field is generated between the electrodes 234 and 232a of the signal electrode 230 forming the signal line, the same velocity matching as described above can be performed.

In the present embodiment, the recess portion 1040 is formed as one groove having a width including the gaps g1a, g2a, g1b, and g2b, but is not limited thereto. For example, the recess portion 1040 may be formed to be divided into a first recess portion having a width including a portion directly under the parallel waveguide 226a and the gaps g1a and g2a, and a second recess portion having a width including a portion directly under the parallel waveguide 226b and the gaps g1b and g2b. In this case, velocity matching between a propagation velocity of light in the parallel waveguide 226a and a propagation velocity of a high-frequency electrical signal in the signal electrode 930a and velocity matching between a propagation velocity of light in the parallel waveguide 226b and a propagation velocity of a high-frequency electrical signal in the signal electrode 930b can be performed individually by the first recess portion and the second recess portion.

Here, desirable conditions and the like for dimensions such as T1, T2, T3, T4, and W1 described for the optical modulation element 102 may also be applied to the optical modulation element 802. Modifications of the above-described materials of the filling substance 350, filling aspects, and the like may be applied to the filling substance 1050 in the optical modulation element 802.

Also in the optical modulation element 802, as described above for the optical modulation element 102, as the optical waveguide 224, a planar waveguide as illustrated in FIG. 4 may be used instead of the ridge type waveguide.

The present invention is not limited to the configurations of the above-described embodiment and modification examples thereof, and may be implemented in various aspects without departing from the concept thereof.

For example, in the above-described embodiments, the support substrate 222 has a uniform refractive index, but is not limited thereto. The support substrate 222 may be a multilayer substrate formed of a plurality of layers that are respectively made of different materials. In this case, among the layers forming the support substrate 222, the recess portion 340 may be formed in the upper layer including the surface to be bonded to the optical substrate 220, or the recess portion 340 may be formed over the upper layer and one or a plurality of lower layers thereunder. In this case, the refractive index n3 of only the surface of the support substrate 222 that is bonded to the optical substrate 220 and/or a portion including the bonded surface (for example, a portion of the upper layer) may be higher than the condition for n3 described above, that is, the substrate refractive index n1 of the optical substrate 220.

Alternatively, the support substrate 222 may be configured such that the refractive index is distributed in the thickness direction. In this case, a portion of the support substrate 222 from the upper surface bonded to the optical substrate 220 to the depth of the bottom surface of the recess portion 340 may have a refractive index higher than the above-described condition for n3, that is, the substrate refractive index n1 of the optical substrate 220.

That is, the portion of the support substrate 222 from the upper surface to at least the depth of the bottom surface of the recess portion 340 (that is, the portion from the upper surface to the depth T3) may have a refractive index higher than the substrate refractive index n1 of the optical substrate 220.

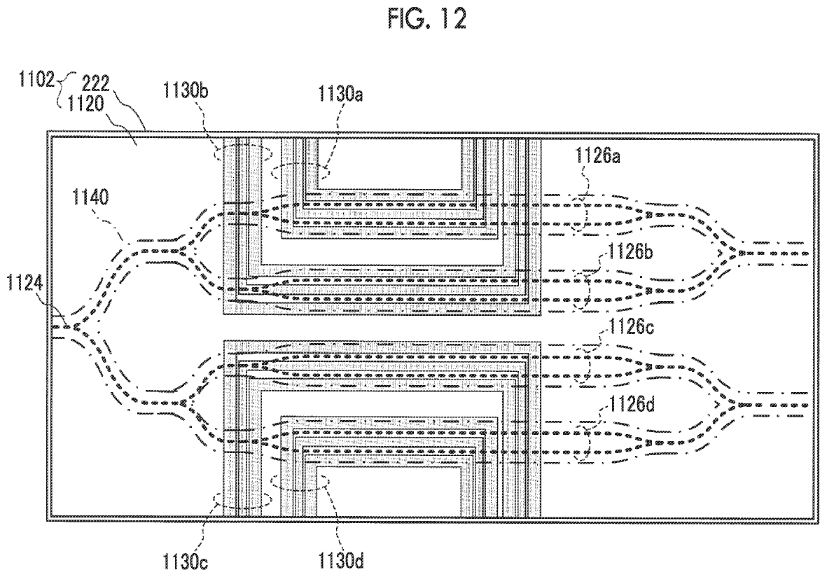

For example, in the present embodiment, as the optical modulation elements 102 and 802, the optical modulation element in which the optical modulation operation is performed by the optical waveguide 224 configuring a single Mach-Zehnder optical waveguide including a pair of parallel waveguides 226a and 226b has been described, the present invention is not limited thereto. For example, an optical modulation element 1102 that performs DP-QPSK modulation and is configured by using two so-called nested Mach-Zehnder optical waveguides as illustrated in FIG. 12 may be used.

The optical modulation element 1102 may include, for example, an optical substrate 1120 that is an X-cut LN substrate having the same substrate refractive index n1 as that of the optical substrate 220, and a support substrate 222 bonded to the optical substrate 1120. In the same manner as the recess portion 340 in the first embodiment, the support substrate 222 may be provided with a recess portion 1140 (a portion sandwiched between dot chain lines in the figure) formed to have a width including a portion directly under the optical waveguide 1124 along the optical waveguide 1124 (a thick dotted line in the figure) formed on the optical substrate 1120.

In the same manner as in the second embodiment described above, for each of the parallel waveguide pairs 1126a, 1126b, 1126c, and 1126d of which refractive indexes are respectively controlled by the signal electrodes 1130a, 1130b, 1130c, and 1130d forming signal lines, the recess portion 1140 may be formed to have a groove width including a portion directly under the corresponding parallel waveguide and a gap between the electrodes of the corresponding signal lines to achieve velocity matching between guided light and a high-frequency electrical signal.

In the optical modulation element 1102 illustrated in FIG. 12, light input to the optical waveguide 1124 from the left side in the figure is output from the right side in the figure as two QPSK-modulated output light beams. The two output light beams are polarized and combined by an appropriate space optical system according to a technique of the related art, combines into one light beam, coupled with, for example, an optical fiber, and guided to a transmission channel optical fiber.

As described above, the optical modulation element 102 that is the optical waveguide element described in the present embodiment includes the optical substrate 220 on which the optical waveguide 224 is formed and the support substrate 222 bonded to the optical substrate 220. The recess portion 340 is formed directly under the optical waveguide 224 in the bonded surface of the support substrate 222 with the optical substrate 220 along the optical waveguide 224 on the optical substrate 220. The portion of the support substrate 222 including the bonded surface has the refractive index n3 higher than the substrate refractive index n1 of the optical substrate 220. The recess portion 340 is filled with the filling substance 350 such as a substance having the refractive index n2 lower than the substrate refractive index n1.

According to this configuration, it is possible to eliminate unnecessary light leaking from the optical waveguide 224 into the optical substrate 220 to the support substrate 222 while sufficiently ensuring the confinement of light in the optical waveguide 224. Thus, in the above configuration, it is possible to effectively suppress deterioration in the performance of the optical function performed by using the optical waveguide 224 due to recoupling of unnecessary light with the optical waveguide 224, for example, deterioration in an extinction ratio of the optical modulation element 102 configured by the optical waveguide 224.

In the optical modulation element 102, the optical substrate 220 has the thickness T2 equal to or less than twice the vertical mode field diameter T1 of light propagating through the optical waveguide 224 in the thickness direction of the optical substrate 220. According to this configuration, even in a case where the thinly processed optical substrate 220 that is likely to cause recoupling of unnecessary light with the optical waveguide 224 is used, the recoupling can be effectively suppressed and favorable optical characteristics can be obtained.

In the optical modulation element 102, the recess portion 340 is formed such that the groove width W2 measured in the direction orthogonal to the extending direction of the optical waveguide 224 is equal to or more than the horizontal mode field diameter W1 of light (propagating light) propagating through the optical waveguide 224, measured in the plane direction of the optical substrate 220. According to this configuration, the recess portion 340 can cover the entire horizontal spread of the mode field 360 of the propagating light, and thus it is possible to sufficiently ensure confinement of light in the optical waveguide 224 in the thickness direction of the optical substrate 220 by using the filling substance 350 in the recess portion 340.

In the optical modulation element 102, the optical substrate 220 and the support substrate 222 are bonded to each other with the adhesive layer 370 interposed therebetween. The adhesive layer 370 is formed to have the thickness T4 that is equal to or less than 1/50 of the vertical mode field diameter T1 of guided light in the optical waveguide 224. According to this configuration, unnecessary light in the optical substrate 220 is easily leaked and is transmitted through the adhesive layer 370, and is effectively eliminated to the support substrate 222.

In the optical modulation element 102, the recess portion 340 is formed to have the depth T3 that is equal to or more than 1/40 of the vertical mode field diameter T1. According to this configuration, the recess portion 340 filled with the filling substance 350 effectively functions as a clad layer of the optical waveguide 224, and light can be sufficiently confined in the optical waveguide 224.

The optical modulation element 802 is provided with the signal electrodes 930a and 930b that are disposed along the parallel waveguide 226a or 226b that is a part of the optical waveguide 224 and form signal lines for controlling optical waves propagating through the parallel waveguides 226a and 226b on the optical substrate 820. The recess portion 340 is configured such that the groove width W2 includes a gap between the electrode 932a and the like forming the signal lines. The filling substance 350 in the recess portion 340 has a dielectric constant lower than that of the optical substrate 220.

According to this configuration, in the parallel waveguides 226a and 226b in which optical waves are controlled by the signal lines, a propagation velocity of guided light in the parallel waveguides 226a and 226b can be matched with a propagation velocity of high-frequency electrical signals in the signal lines. Therefore, the bandwidth of light wave control can be easily expanded. This effect can be similarly achieved as long as the groove width W2 of the recess portion 340 includes at least a part of the gap between the electrodes forming the signal lines.

The support substrate 222 of the optical modulation element 102 or 802 may be a multilayer substrate including a plurality of layers made of different materials. The support substrate 222 of the optical modulation elements 102 and 802 may be configured such that the refractive index is distributed in the thickness direction of the support substrate 222. According to this configuration, as long as the refractive index n3 of only the surface of the support substrate 222 that is bonded to the optical substrate 220 and the portion including the bonded surface satisfies the above conditions, for example, a multilayer substrate in which a layer having the refractive index of n3 is provided adjacent to a layer made of a robust material can be used as the support substrate 222, or, for example, a substrate provided with a portion satisfying the conditions for n3 by performing ion implantation, ion diffusion, or the like on a robust material of which a refractive index does not satisfy the above-described conditions for n3 is satisfied with n3 by ion can be used as the support substrate 222. Therefore, many materials can be used for the support substrate 222, and thus the degree of freedom in design is improved. A layer having the refractive index n3 or a portion including a surface to be bonded to the optical substrate 220 may be formed on the support substrate 222 may be formed either before or after the recess portion 340 is formed.

The optical modulation element 102 and the filling substance 350 contains at least one of a gas such as air and nitrogen, a resin, SiOₓ, Al₂O₃, MgF₂, and CaF₂. According to this configuration, the filling substance 350 can function as an effective clad layer for the optical waveguide 224 without using a special material as the filling substance 350 in the recess portion 340.

The optical modulation devices 100 and 800 that are the optical waveguide devices of the above-described embodiments include the optical modulation elements 102 and 802 that are optical waveguide elements having any of the above configurations, and the housing 104 including the optical waveguide elements. According to this configuration, unnecessary light leaking from the optical waveguide 224 to the optical substrates 220 and 820 is effectively eliminated to the support substrate 222, and thus it is possible to implement the optical waveguide device in which the deterioration in optical characteristics such as an extinction ratio of an optical modulation waveform is effectively suppressed.

### REFERENCE SIGNS LIST

100, 800 Optical modulation device
102, 802, 1102 Optical modulation element
104 Housing
106 Input optical fiber
108 Output optical fiber
110 Connector
112 Relay substrate
114 Terminator
220, 420, 820, 1120 Optical substrate
222 Support substrate
224, 1124 Optical Waveguide
226a, 226b Parallel waveguide
230, 930a, 930b, 1130a, 1130b, 1130c, 1130d Signal electrode
232, 234, 236, 932a, 932b, 934a, 934b, 936a, 936b Electrode
340, 1040, 1140 Recess portion
350, 1050 Filling substance
360 Mode field
370, 1070 Adhesive layer
652 Air
654 Resin
656 Intermediate layer
962 Buffer layer
1126a, 1126b, 1126c, 1126d Parallel waveguide pair

1. An optical waveguide element comprising:
an optical substrate on which an optical waveguide is formed; and
a support substrate that is bonded to the optical substrate, wherein
on a bonded surface of the support substrate bonded to the optical substrate, a recess portion along the optical waveguide on the optical substrate is formed directly under the optical waveguide,
a refractive index of a portion including the bonded surface of the support substrate is higher than a substrate refractive index of the optical substrate, and
the recess portion is filled with a substance having a refractive index lower than the substrate refractive index.

2. The optical waveguide element according to claim 1, wherein
the optical substrate has a thickness that is equal to or less than twice a vertical mode field diameter of light propagating through the optical waveguide, the vertical mode field diameter being a diameter of said light in a thickness direction of the optical substrate.

3. The optical waveguide element according to claim 1, wherein
the recess portion is formed such that a groove width of the recess portion measured in a direction orthogonal to an extending direction of the optical waveguide is equal to or more than a horizontal mode field diameter of the light propagating through the optical waveguide, the horizontal mode field diameter being measured in a plane direction of the optical substrate.

4. The optical waveguide element according to claim 1, wherein
the optical substrate and the support substrate are bonded to each other with an adhesive layer interposed therebetween, and
wherein the adhesive layer is formed to have a thickness that is equal to or less than 1/50 of a vertical mode field diameter of light propagating through the optical waveguide, the vertical mode field diameter being a diameter of said light in a thickness direction of the optical substrate.

5. The optical waveguide element according to claim 1, wherein
the recess portion is formed at a depth that is equal to or more than 1/40 of a vertical mode field diameter of light propagating through the optical waveguide, the vertical mode field diameter being a diameter of said light in a thickness direction of the optical substrate.

6. The optical waveguide element according to claim 1, wherein
the optical substrate is provided with a signal line disposed along the optical waveguide and controlling an optical wave propagating through the optical waveguide,
the recess portion is configured such that a groove width of the recess portion measured in a direction orthogonal to an extending direction of the optical waveguide includes at least a part of a gap between electrodes forming the signal line, and
the substance has a dielectric constant lower than a dielectric constant of the optical substrate.

7. The optical waveguide element according to claim 1, wherein
the support substrate is a multilayer substrate including a plurality of layers made of different materials.

8. The optical waveguide element according to claim 1, wherein
the support substrate is configured such that a refractive index is distributed in a thickness direction.

9. The optical waveguide element according to claim 1, wherein
the substance includes at least one of air, nitrogen, resin, SiOₓ, Al₂O₃, MgF₂, and CaF₂.

10. An optical waveguide device comprising:
the optical waveguide element according to claim 1; and
a housing that houses the optical waveguide element.

11. The optical waveguide element according to claim 2, wherein
the recess portion is formed such that a groove width of the recess portion measured in a direction orthogonal to an extending direction of the optical waveguide is equal to or more than a horizontal mode field diameter of the light propagating through the optical waveguide, the horizontal mode field diameter being measured in a plane direction of the optical substrate.

12. The optical waveguide element according to claim 2, wherein
the optical substrate and the support substrate are bonded to each other with an adhesive layer interposed therebetween, and
wherein the adhesive layer is formed to have a thickness that is equal to or less than 1/50 of a vertical mode field diameter of light propagating through the optical waveguide, the vertical mode field diameter being a diameter of said light in a thickness direction of the optical substrate.

13. The optical waveguide element according to any one of claims 1 to 4, wherein
the recess portion is formed at a depth that is equal to or more than 1/40 of a vertical mode field diameter of light propagating through the optical waveguide, the vertical mode field diameter being a diameter of said light in a thickness direction of the optical substrate.

14. The optical waveguide element according to claim 2, wherein
the optical substrate is provided with a signal line disposed along the optical waveguide and controlling an optical wave propagating through the optical waveguide,
the recess portion is configured such that a groove width of the recess portion measured in a direction orthogonal to an extending direction of the optical waveguide includes at least a part of a gap between electrodes forming the signal line, and
the substance has a dielectric constant lower than a dielectric constant of the optical substrate.

15. The optical waveguide element according to claim 2, wherein
the support substrate is a multilayer substrate including a plurality of layers made of different materials.

16. The optical waveguide element according to claim 2, wherein
the support substrate is configured such that a refractive index is distributed in a thickness direction.

17. The optical waveguide element according to claim 2, wherein
the substance includes at least one of air, nitrogen, resin, SiOₓ, Al₂O₃, MgF₂, and CaF₂.
